(19) United States
(12) Patent Application Publication
(10) Pub. No.: US 2026/0362249 A1
(43) Pub. Date: Nov. 12, 2026

(54) REPORT RECORDING METHOD AND APPARATUS AND COMMUNICATION SYSTEM

(71) Applicant: 1FINITY Inc., Kawasaki-shi (JP)

(72) Inventor: Tingting GENG, Beijing (CN)

(73) Assignee: 1FINITY Inc., Kawasaki-shi (JP)

(21) Appl. No.: 19/743,686

(22) Filed: Jul. 16, 2026

Related U.S. Application Data
(63) Continuation of application No. PCT/CN2024/088079, filed on Apr. 16, 2024.

(30) Foreign Application Priority Data
Jan. 23, 2024 (WO) PCT/CN2024/073708

(51) Int. Cl. H04W 36/00

(52) U.S. Cl. CPC H04W 36/0058; H04W 36/00835

(57) ABSTRACT

An apparatus includes: a receiver configured to receive first configuration information indicating a configuration of a primary secondary cell (PSCell) change, the PSCell change comprising a first type of a PSCell change or a second type of a PSCell change, wherein the first type of a PSCell change is a PSCell change where the terminal equipment executes a PSCell change procedure immediately upon receiving a target PSCell configuration transmitted by a network device, and wherein the second type of a PSCell change is a conditional PSCell change; and processor circuitry configured to record a first report according to whether a first indication information is configured and a type of a PSCell change, wherein the first indication information is used to indicate that the first type of a PSCell change or the second type of a PSCell change comprised in the first configuration information is initiated by a secondary network device.

### CROSS-REFERENCE TO RELATED APPLICATION

This application is a continuation application under 35 U.S.C. 111(a) of International Patent Application PCT/CN2024/088079 filed on Apr. 16, 2024, which claims priority of International Patent Application PCT/CN2024/073708 filed on Jan. 23, 2024, the entire contents of each are incorporated herein by reference.

### TECHNICAL FIELD

This disclosure relates to the field of communication technologies.

### BACKGROUND

In dual-connectivity (DC) or multi-connectivity (MC) communication, a terminal equipment may simultaneously have communication connections with at least two access network devices, such as a master base station and one or more secondary base stations. The master base station manages a master cell group (MCG), and the secondary base station manages a secondary cell group (SCG). A terminal equipment may obtain communication services of the master base station via a cell in the MCG, and may obtain communication services of the secondary base station via a cell in the SCG. In the DC or MC, scenarios of primary secondary cell addition or secondary cell change of a terminal equipment will frequently happen.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

A terminal equipment may record a problem of potential failure occurring during a primary secondary cell addition or change procedure. However, there is currently no technical solution as to how the terminal equipment determines whether to record the problem of potential failure and which information needs to be recorded.

In order to solve at least one of the above problems or other similar problems, embodiments of this disclosure provide a report recording method and apparatus and a communication system.

According to one aspect of the embodiments of this disclosure, there is provided a report recording apparatus, applicable to a terminal equipment, wherein the device includes:
a receiver configured to receive first configuration information indicating a configuration of a primary secondary cell (PSCell) change, the PSCell change including an ordinary PSCell change or a conditional PSCell change; and
a processor configured to determine to record a first report according to a type of the PSCell change, and/or according to relevant information of a target PSCell, and/or according to a type of a signaling radio bearer (SRB) transmitting the first configuration information.

According to another aspect of the embodiments of this disclosure, there is provided a report recording method, wherein the method includes:
receiving first configuration information indicating a configuration of a primary secondary cell (PSCell) change by a terminal equipment, the PSCell change including an ordinary PSCell change or a conditional PSCell change; and
determining by the terminal equipment to record a first report according to a type of the PSCell change, and/or according to relevant information of a target PSCell, and/or according to a type of a signaling radio bearer (SRB) transmitting the first configuration information.

According to a further aspect of the embodiments of this disclosure, there is provided a communication system, including the report recording apparatus described in the one aspect.

An advantage of the embodiments of this disclosure exists in that according to the embodiments of this disclosure, the terminal equipment is enabled to determine a network device triggering mobility of a primary secondary cell, thereby determining whether to record a problem of potential failure in a primary secondary cell mobility procedure and the recorded contents, which avoids recording erroneous or redundant contents, ensures robustness, and reduces unnecessary signaling overhead.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of this disclosure may be combined with elements and features depicted in more than one additional drawings or embodiments. Moreover, in the drawings, like reference numerals designate corresponding parts throughout the several views and may be used to designate like or similar parts in more than one embodiment.

FIG. 1 is schematic diagram of a master cell group and a secondary cell group;

FIG. 2 is a schematic diagram of a report recording method of the embodiments of this disclosure;

FIG. 3 is a schematic diagram of a report transmission method of the embodiments of this disclosure;

FIG. 4 is a schematic diagram of a report reception method of the embodiments of this disclosure;

FIG. 5 is a schematic diagram of a report recording apparatus of the embodiments of this disclosure;

FIG. 6 is a schematic diagram of a communication system of the embodiments of this disclosure;

FIG. 7 is a schematic diagram of a terminal equipment of the embodiments of this disclosure; and

FIG. 8 is a schematic diagram of a network device of the embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, scenarios containing a network device and/or a terminal equipment are taken as examples.

In the above scenarios, the network device may include at least one of a core network device, a third-party application device, operation administration and maintenance (OAM), and an access network device.

The core network device may refer to a device in a core network (CN) providing service support to a terminal equipment. As some instances, the core network device may be at least one of the following: a mobility and management entity (MME), an access and mobility management function (AMF) entity, a session management function (SMF) entity, a user plane function (UPF) entity, and a location management function (LMF) entity, etc., which shall not be enumerated herein any further. The AMF entity may be responsible for access management and mobility management of a terminal, the SMF entity may be responsible for session management, such as establishment of a user session, and the UPF entity may be a functional entity of a user plane, and is mainly responsible for connection to external networks. The LMF entity may manage overall coordination and scheduling of resources required by a location of a terminal equipment registered to the core network device or accessed to the core network device. It should be noted that in this disclosure, an entity may also be referred to as a network element or a functional entity, for example, the AMF entity may also be referred to as an AMF network element or an AMF functional entity, etc.

The third-party application device may be an OTT server (over the top server) or another third-party device.

The OAM may be a network device that performs operations, administration, maintenance, and other management tasks on the network according to actual needs of network operations of an operator.

The access network device is an access device of a terminal that accesses to a communication system in a wireless manner. The access network device may be a base station (BS), an evolved base station (evolved NodeB, eNodeB), a transmission reception point (TRP), a base station in a fifth generation (5G) mobile communication system (next generation NodeB, gNB), a base stations in a sixth generation (6G) mobile communication system, a base station in a future mobile communication system or access node in a WiFi system, etc.; the access network device may also be a module or unit that completes a part of functions of a base station, for example, it may be at least one of the following modules or units: a centralized unit (CU), a distributed unit (DU), a centralized unit control plane (CU-CP), a centralized unit user plane (CU-CP), an integrated access backhaul (IAB), or other modules or units. Specific techniques and/or specific device forms adopted by the access network device are not limited in the embodiments of this disclosure. The access network device may be deployed on the land, including indoors/outdoors, and may be handheld or on-board; and it may also be deployed on a water surface, an airplane, a balloon or a satellite. The access network device may be deployed at a fixed position or on a mobile carrier, which is not limited in the embodiments of this disclosure.

In the above scenarios, the terminal equipment is an equipment having a function of wireless transmission and reception, and may transmit signals to the access network device and/or receive signals from the access network device. The terminal equipment may also be referred to as a terminal, a mobile station, and a mobile terminal, etc. The terminal equipment may be a mobile phone, a tablet, or other equipments having a function of wireless intelligent transmission and reception. The terminal equipment may be widely used in various scenarios, such as device-to-device (D2D), vehicle to everything (V2X) communication, machine-type communication (MTC), Internet of Things (IoT), virtual reality, augmented reality, industrial control, autonomous driving, telemedicine, or various intelligent scenarios.

In the above scenarios, communication may be performed between the access network device and the terminal equipment and between terminal equipments via licensed spectra or via unlicensed spectra, or via licensed spectra and unlicensed spectra simultaneously. Spectrum resources used in the wireless communication are not limited in the embodiments of this disclosure.

For ease of description, following description shall be given by taking that a base station serves as an access network device as an example. In the following description, without causing confusion, “if . . . ”, “in a case where . . . ” and “when . . . ” may be used interchangeably.

The embodiments of this disclosure are mainly described for a multi-connectivity scenario. For ease of understanding, an MC scenario including two connections, namely a DC scenario, is taken as an example. It should be noted that in the embodiments of this disclosure, multi-link may also be referred to as multi-connectivity, and dual-link may also be referred to as dual-connectivity.

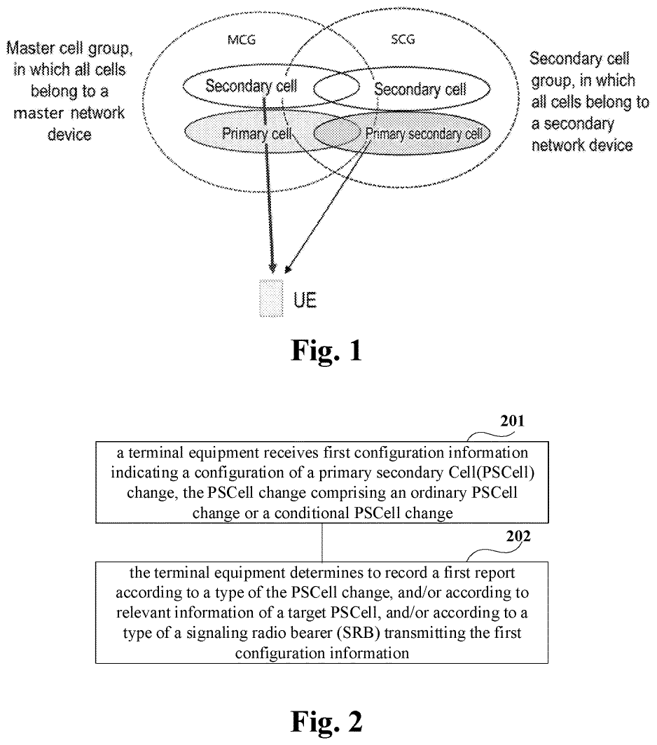

In the dual-connectivity scenario, as shown in FIG. 1, a terminal equipment is configured with a master network device and a secondary network device. A group of serving cells associated with the master network device may be referred to as an MCG, and a group of serving cells associated with the secondary network device may be referred to as an SCG. The master cell group may include a primary cell (PCell), or a primary cell and at least one secondary cell (SCell), and the secondary cell group may include a primary SCG cell (PSCell), or a PSCell and at least one secondary cell. The primary cell and the primary SCG cell may also be referred to as special cells (SpCells).

In the embodiments of this disclosure, a master base station may also be referred to as a master node (MN) or a master network device or a master cell. A secondary base station may also be referred to as a secondary node (SN) or a secondary network device. A control-plane connection may be established between the master base station and a core network, and data-plane connections may be established between the master base station and the core network and between the secondary base station and the core network.

SN-related mobility (which may be referred to as secondary base station mobility or primary secondary cell mobility or secondary cell group mobility) is concerned below. A “primary secondary cell” is taken as an example in description, and description of the primary secondary cell may be extended to description of a secondary cell group or a secondary network device, which are not limited in the embodiments of this disclosure.

The scenario of primary secondary cell mobility may include at least one of the following:
primary secondary cell addition: in a wireless communication system, a terminal equipment is configured only with a primary cell or a master cell group, and the primary cell or master cell group belongs to a master network device. The master network device adds a primary secondary cell for the terminal equipment. A possible addition mode is: configuring the terminal equipment by the master network device to add a target primary secondary cell, and immediately performing a target primary secondary cell addition procedure by the terminal equipment, and this mode is referred to as an ordinary (or legacy) primary secondary cell addition mechanism; or, configuring a candidate primary secondary cell and a corresponding execution condition by the master network device for the terminal equipment, and when a execution condition to which the candidate primary secondary cell corresponds is satisfied, adding the candidate primary secondary cell satisfying the execution condition as a target primary secondary cell by the terminal equipment, that is, performing a target primary secondary cell addition procedure by the terminal equipment, and this mode is referred to as a conditional primary secondary cell addition mechanism;
primary secondary cell change: this may also be referred to as primary secondary cell change. In a wireless communication system, a terminal equipment may be configured with dual-connectivity, and may establish connections with a master network device and a secondary network device, respectively. The master network device may be referred to as a source master network device, and the secondary network device may be referred to as a source secondary network device. When the master network device of the terminal equipment remains unchanged, the secondary network device or the primary secondary cell or the secondary cell group of the terminal equipment may be changed. The change may be triggered by the master network device or by the source secondary network device. The primary secondary cell change may be across the secondary network device or within the source secondary network device. Taking that the network device is a base station as an example, the master network device may be an MN, and the secondary network device may be an SN or a source SN. A primary secondary cell change across the secondary network device may be referred to as inter-SN primary secondary cell change, and a new secondary network device may be referred to as a target SN. A primary secondary cell change within the source secondary network device may be referred to as intra-SN primary secondary cell change. As an example, the target SN and the source SN in this scenario are identical. Similarly, the above change mode may be an ordinary primary secondary cell change mechanism, that is, the network device configures the terminal equipment with a target primary secondary cell, and the terminal equipment immediately executes a target primary secondary cell change process; or it may also be a conditional primary secondary cell change mechanism, that is, the network device configures candidate primary secondary cells and corresponding execution conditions for the terminal equipment, and when an execution condition to which the candidate primary secondary cells correspond is satisfied, the terminal equipment selects a target primary secondary cell from the candidate primary secondary cells satisfying the condition and executes a target primary secondary cell change process. In the conditional change mechanism, the master network device and the source secondary network device may separately configure or may simultaneously configure the candidate primary secondary cells and execution conditions. In a scenario of ordinary primary secondary cell mobility, configuration may be performed only by the master network device or the secondary network device. It should be noted that in the embodiments of this disclosure, when a primary secondary cell/SN/secondary network device is/are present, they/it may be understood as a “source” primary secondary cell/SN/secondary network device, unless they/it are/is explicitly described as a “target” primary secondary cell/SN/secondary network device.

In summary, scenarios of primary secondary cell mobility that may possibly exist include:
1) primary secondary cell addition-MN triggered/configured;
2) ordinary intra-SN primary secondary cell change-SN triggered/configured;
3) ordinary inter-SN primary secondary cell change-SN triggered/configured;
4) ordinary primary secondary cell change-MN triggered/configured;
5) conditional intra-SN primary secondary cell change-SN triggered/configured;
6) conditional inter-SN primary secondary cell change-SN triggered/configured; and
7) conditional primary secondary cell change-MN triggered/configured.

A successful primary secondary cell report (successful PSCell report, SPR) is introduced into 3GPP Release 18, which is used for identifying a problem of potential failures in a secondary base station mobility or primary secondary cell mobility or secondary cell group mobility procedure. In order to enable a terminal equipment to record an SPR, a network device may configure an SPR triggering condition for the terminal equipment. It should be noted that if the network device triggers/configures primary secondary cell mobility, the network device may further configure an SPR triggering condition for the terminal equipment. For example, in a primary secondary cell change scenario, correspondingly, both the master network device and the source secondary network device may configure corresponding SPR triggering conditions for the terminal equipment.

It was found by the inventors that in a primary secondary cell change scenario, both the master network device and the secondary network device may configure primary secondary cell change for the terminal equipment. Correspondingly, both the master network device and the secondary network device may configure corresponding SPR triggering conditions for the terminal equipment. Therefore, the terminal equipment needs to determine a network device which triggers and/or configures the primary secondary cell change procedure executed by the terminal equipment and/or the SPR triggering condition used by the terminal equipment. If the terminal equipment always records an SPR according to configurations of both the master network device and the source secondary network device, unnecessary signaling overhead may be incurred. Or, if the primary secondary cell change procedure of the terminal equipment is triggered/configured by the master network device (or the source secondary network device), but the terminal equipment determines recording of the SPR according to the SPR triggering condition configured by the source secondary network device (or the master network device) and/or records the SPR according to the configuration of the source secondary network device (or the master network device), the master network device may possibly be unable to optimize mobility parameters of corresponding primary secondary cell change triggered/configured by the master network device according to the SPR. In view of at least one of above problems, embodiments of this disclosure provide a report recording method and apparatus and a communication system.

Embodiments of this disclosure shall be described below with reference to the accompanying drawings and specific implementations.

### Embodiment of a First Aspect

The embodiments of this disclosure provide a report recording method, which shall be described from a terminal equipment side.

FIG. 2 is a schematic diagram of the report recording method of the embodiments of this disclosure. As shown in FIG. 2, the method includes:
201: a terminal equipment receives first configuration information indicating a configuration of a primary secondary Cell (PSCell) change, the PSCell change comprising an ordinary PSCell change or a conditional PSCell change; and
202: the terminal equipment determines to record a first report according to a type of the PSCell change, and/or according to relevant information of a target PSCell, and/or according to a type of a signaling radio bearer (SRB) transmitting the first configuration information.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, an implementation of the ordinary primary secondary cell change or the conditional primary secondary cell change is as described above, which shall not be repeated herein any further. That is, the first configuration information may be an ordinary primary secondary cell change configuration, and includes target primary secondary cell information. Or, the first configuration information may be a conditional primary secondary cell change configuration, which includes candidate primary secondary cell information and execution condition information.

In some embodiments, the first configuration information is used for the terminal equipment to determine a (changed) target primary secondary cell. If the first configuration information is an ordinary primary secondary cell change configuration, the ordinary primary secondary cell change configuration includes information of the target primary secondary cell, and the terminal equipment may directly determine the target primary secondary cell according to the information of the target primary secondary cell and execute a corresponding change process, and if the first configuration information is a conditional primary secondary cell change configuration, the conditional primary secondary cell change configuration includes candidate primary secondary cell information and execution condition information. For example, the conditional primary secondary cell change configuration may include information of at least one candidate primary secondary cell and execution condition information, the terminal equipment respectively determines whether candidate primary secondary cells in a candidate primary secondary cell list satisfy execution conditions in the execution condition information, selects a target primary secondary cell from candidate primary secondary cells satisfying the conditions, and executes corresponding change processes. Reference may be made to relevant technologies for the above change processes, which shall not be repeated herein any further.

In some embodiments, the primary secondary cell change configuration in the first configuration information is configured by the (source) master network device (primary cell), or by the (source) secondary network device (primary secondary cell), or by the (source) master network device and the (source) secondary network device. Or, in other words, the primary secondary cell change is triggered by the (source) master network device, or by the (source) secondary network device, or by the (source) master network device and the (source) secondary network device.

In some embodiments, optionally, the first configuration information may further include maximum runtime information of at least one timer, the at least one timer including T304, T310, and/or T312, etc. For ease of understanding, timers involved in this disclosure shall be described below.

Timer T304 (hereinafter referred to as T304):
a runtime of T304 indicates a duration from the terminal equipment executes target primary secondary cell addition or change (including ordinary and conditional scenarios) to the UE successfully complete a random access procedure between it and the target primary secondary cell.

Timer T310 (hereinafter referred to as T310):
a runtime of T310 indicates a duration in which the UE detects that there exist physical layer problems (which are usually that continuously received downlink asynchronization indications exceed a certain threshold) between the UE and a network device (such as the source secondary network device or the master network device); after T310 is started, if a radio link is recovered during operation of T310, timer T310 is stopped, and if the runtime of T310 is greater than or equal to a certain threshold, the UE determines that a radio link failure occurs between the UE and the network device (e.g. the source secondary network device or the master network device).

Timer T312 (hereinafter referred to as T312):
maximum runtime information of T312 may be per frequency point or per measurement identification; when the network device configures T312 starting indication information and the maximum runtime information of T312 for the frequency point or measurement identification, if the terminal equipment transmits a measurement report to which the frequency point or measurement identification corresponds, the terminal equipment starts a corresponding T312; furthermore, the terminal equipment may determine whether to start T312 according to whether T310 is running or not. For example, if T310 is running, a frequency point to which the frequency point or measurement identification corresponds is configured with T312 starting indication information and the maximum runtime information of T312, and if the terminal equipment transmits a measurement report to which the frequency point or measurement identification corresponds, the terminal equipment start a corresponding T312; and in a scenario of primary secondary cell mobility, the terminal equipment starts T312 corresponding to a frequency point or measurement identification to which the target primary secondary cell corresponds.

The maximum runtime information of above at least one timer may also be configured by other higher layer parameters, and the embodiments of this disclosure are not limited thereto.

In some embodiments, the first configuration information further includes a record triggering configuration of the first report, the record triggering configuration information being used by the terminal equipment to determine whether to record the first report. The first report may be the above successful primary secondary cell report (SPR); the embodiments of this disclosure are not limited to this name. The record triggering configuration is used for the terminal equipment to determine whether a potential failure occurs in the primary secondary cell mobility process, or for the terminal equipment to determine whether recording the first report is needed according to the record triggering configuration. How to determine whether recording the first report is needed according to the record triggering configuration shall be described below. Recording the first report indicates that the terminal equipment stores information related to the primary secondary cell mobility.

In some embodiments, the record triggering configuration may include a trigger threshold of at least one timer, the at least one timer including T304, T310, and/or T312. That the terminal equipment determines whether recording the first report is needed according to the record triggering configuration includes: determining by the terminal equipment to record the first report if the terminal equipment determines that the information related to the runtime of the timer to which the record triggering configuration corresponds is greater than or equal to the trigger threshold to which the timer corresponds; otherwise, not recording the first report. The above trigger threshold may be absolute time length information or ratio information. As an implementation, if the above trigger threshold is ratio information, when the terminal equipment determines that a ratio of the runtime of the timer to the maximum runtime of the timer is greater than or equal to the trigger threshold to which the timer corresponds, the terminal equipment determines to record the first report.

For example, if a ratio of a runtime of T304 to a maximum runtime of T304 is greater than or equal to a trigger threshold of T304, the UE records the first report. If a ratio of a runtime of T310 (to which the source primary secondary cell corresponds) to a maximum runtime of T310 is greater than or equal to a trigger threshold of T310, the UE records the first report. If a ratio of a runtime of T312 (to which the target primary secondary cell corresponds) to a maximum runtime of T312 is greater than or equal to a trigger threshold of T312, the UE records the first report.

In some embodiments, the record triggering configuration is configured by the (source) master network device, or by the (source) secondary network device, or by the (source) master network device and the (source) secondary network device respectively. The record triggering configuration and the primary secondary cell change configuration are carried by identical or different signaling, and the embodiments of this disclosure are not limited thereto.

As described above, in the scenario of primary secondary cell change, both the master network device and secondary network device may configure primary secondary cell changes for the terminal equipment. Correspondingly, both the master network device and secondary network device may configure corresponding record triggering configurations for the terminal equipment. That is, when the terminal equipment determines whether to record the first report, conditions needing to be considered shall include distinguishing network devices which trigger and/or configure corresponding configurations, so as to avoid recording errors or signaling overhead caused by adding unnecessary records, which shall be described below in detail.

In some embodiments, first indication information may be introduced, which is used to indicate a network device which configures the first configuration information (a network device which triggers the primary secondary cell change). If the first indication information is used to indicate that the first configuration information is configured by the secondary network device (the primary secondary cell change is triggered by the secondary network device), the first configuration information may or may not include the first indication information, or, in other words, the first indication information may or may not be configured. When the first configuration information includes the first indication information (when the first indication information is configured), it indicates that the first configuration information (primary secondary cell change configuration) is configured by the secondary network device, and when the first configuration information does not include the first indication information (when the first indication information is not configured), it indicates that the first configuration information (primary secondary cell change configuration) is configured by the master network device. That is, the terminal equipment determines a network device which triggers and/or configures the primary secondary cell change configuration according to whether the first indication information is configured, and then determines whether to record the first report according to a record triggering configuration of the determined network device. The first indication information and the above primary secondary cell change configuration may be carried by identical or different signaling, or the first indication information may be included in the primary secondary cell change configuration, and the embodiments of this disclosure is not limited thereto.

As a possible implementation (hereinafter referred to as Implementation 1), taking that the first indication information is used to indicate that the first configuration information is configured by the (source) secondary network device (the primary secondary cell change is triggered by the (source) secondary network device) as an example, the first indication information is only used to indicate whether an ordinary primary secondary cell change configuration is configured by the (source) primary secondary cell or by the (source) secondary network device, including scenarios where a corresponding primary secondary cell change configuration (first configuration information) is transmitted via SRB1 and SRB3. That is, only when an ordinary primary secondary cell change configuration is transmitted, the first indication information may be configured (including being configured (by the (source) primary secondary cell or by the (source) secondary network device) or may not be configured (being configured by the (source) primary cell or by the (source) master network device), and under the conditional primary secondary cell change configuration, the first indication information will not be configured.

As a possible implementation (hereinafter referred to as Implementation 2), taking that the first indication information is used to indicate that the first configuration information is configured by the (source) secondary network device (the primary secondary cell change is triggered by the (source) secondary network device) as an example, the first indication information is only used to indicate that the an ordinary primary secondary cell change configuration is configured by the (source) primary secondary cell or by the (source) secondary network device, but a scenario where a corresponding primary secondary cell change configuration (first configuration information) is transmitted via SRB1 is only included. That is, the first indication information may be configured (including being configured (by the (source) primary secondary cell or by the (source) secondary network device) or may not be configured (by the (source) primary cell or by the (source) master network device) only when an ordinary primary secondary cell change configuration is transmitted via SRB1. In other scenarios, the first indication information will not be configured. Or, in other words, when the first configuration information is transmitted via SRB1, the first configuration information may further include the first indication information.

As a possible implementation (hereinafter referred to as Implementation 3), taking that the first indication information used to indicate relevant information of the target primary secondary cell or that the first configuration information is configured by the (source) secondary network device (the primary secondary cell change is triggered by the (source) secondary network device) as an example, the first indication information is used to indicate that the ordinary and/or conditional primary secondary cell change configuration is/are configured by the (source) primary secondary cell or by the (source) secondary network device, including a scenario where a corresponding primary secondary cell change configuration (first configuration information) is transmitted via SRB1 and SRB3. The first indication information may be configured (including when being configured by the (source) primary secondary cell or by the (source) secondary network device) or may not be configured (when being configured by the (source) primary cell or by the (source) master network device).

In Implementation 1, for an ordinary primary secondary cell change (such as scenario 2) or scenario 3) or scenario 4), a network device which triggers and/or configures the primary secondary cell change configuration is determined according to the first indication information. There exists a problem of being unable to determine a corresponding network device according to the first indication information for the conditional primary secondary cell change (such as scenario 5) or scenario 6) or scenario 7).

Similarly, in Implementation 2, there also exists a problem of being unable to determine a corresponding network device only according to the first indication information for the ordinary primary secondary cell change, and there still exists a problem of being unable to determine a corresponding network device according to the first indication information for the conditional primary secondary cell change (such as scenario 5) or scenario 6) or scenario 7).

Similarly, in Implementation 3, a type of the primary secondary cell changes configuration is not distinguished, therefore, there exists also a problem of being unable to determine a corresponding network device only according to the first indication information.

Therefore, in addition to using the first indication information as a determination condition, it is also proposed in the embodiments of this disclosure to distinguish a network device which triggers and/or configures the primary secondary cell change configuration according to a type of the primary secondary cell change, and/or according to relevant information of the target primary secondary cell, and/or according to a type of a signaling radio bearer SRB transmitting the first configuration information, and then determine whether to record the first report according to the record triggering configuration of the network device, and determine contents of the first report according to relevant configurations of the network device, which shall be described below in detail.

As some possible implementations, according to the type of the primary secondary cell change and according to the relevant information of the target primary secondary cell, or, according to the first indication information and the type of the primary secondary cell change and according to the relevant information of the target primary secondary cell, the first report may be determined to be recorded. For example, in Implementation 1 or Implementation 2 or Implementation 3, if the type of the primary secondary cell change is a conditional primary secondary cell change, when the terminal equipment determines that the relevant information of the target primary secondary cell is configured by the first network device, it determines to record the first report according to the record triggering configuration of the first report configured by the first network device. Furthermore, the terminal equipment may determine contents in the first report needing to be recorded according to relevant configurations of the first network device. The first network device is a (source) master network device or a (source) secondary network device. That the terminal equipment determines that the relevant information of the target primary secondary cell is configured by the first network device includes that: the target primary secondary cell is configured by the first network device (for example, the target primary secondary cell is one of candidate primary secondary cells in the primary secondary cell change configuration configured by the first network device), or, an execution condition to which the target primary secondary cell corresponds is configured by the first network device (for example, the target primary secondary cell is a cell satisfying the execution condition in the primary secondary cell change configuration configured by the first network device), or, the first indication information related to the target primary secondary cell is configured, and the first indication information is used to indicate that the target primary secondary cell and/or the execution condition to which the target primary secondary cell corresponds is/are configured by the first network device (for example, the target primary secondary cell is one of candidate primary secondary cells in the primary secondary cell change configuration configured by the first network device, the first indication information related to the target primary secondary cell is configured, and the first indication information is used to indicate that the target primary secondary cell or the execution condition of the target primary secondary cell is configured by the first network device).

For example, both the master network device (MN) and the secondary network device (SN) transmit conditional primary secondary cell change (CPC) configurations and record triggering configurations via SRB1, respectively. The CPC configurations configured by the MN for the UE include {PSCell1, execution condition 1}, and the CPC configurations configured by the SN for the UE include {PSCell 1, execution condition 2} and {PSCell 2, execution condition 3}; or, the CPC configurations configured by the SN for the UE include {PSCell1, execution condition 2, first indication information} and {PSCell2, execution condition 3, first indication information} (at this point, the first indication information is used to indicate that the CPC configurations are configured by the SN). The UE determines that the target primary secondary cell is a PSCell1, and if the target primary secondary cell PSCell1 satisfies execution condition 1, the UE deems that this time of CPC is configured by the MN, and determines whether to record the first report according to an MN-related record triggering configuration. If the target primary secondary cell is PSCell 2, the UE deems that this time of CPC is configured by the SN, or the UE deems that this time of CPC is configured by the SN according to the first indication information related to PSCell 2, and the UE determines whether to record the first report according to an SN-related record triggering configuration.

In this implementation, the terminal equipment may determine a network device which configures the record triggering configuration according to relevant information element information in the record triggering configuration or a transmission mode or the second indication information. For example, a name of the information element information of the record triggering configuration configured by the master network device is different from a name of the information element information of the record triggering configuration configured by the secondary network device, and the terminal equipment may determine a network device which configures the record triggering configuration according to the (names of) the information element information of the record triggering configuration (which may be, for example, applicable to scenario 6) and scenario 7) in Implementation 1 and Implementation 2). For another example, if the record triggering configuration and the primary secondary cell change configuration are included in the same message and transmitted, the terminal equipment may determine that the record triggering configuration information is configured the network device that triggers/configures the primary secondary cell change configuration (which may be, for example, applicable to scenario 5), scenario 6) and scenario 7) in Implementation 1 and Implementation 2). It should be understood that the terminal equipment may determine a network device which triggers/configures the primary secondary cell change configuration according to the information element information or the transmission mode of the execution condition in the conditional primary secondary cell change configuration. For another example, the second indication information may be used to indicate a network device which configures the record triggering configuration (which may be, for example, applicable to scenario 6) and scenario 7) in Implementation 1 and Implementation 2). It should be understood that the second indication information and the first indication information are identical information elements (which may be, for example, applicable to scenario 5), scenario 6) and scenario 7) in Implementation 3), or may be different information elements. Implementation of the second indication information is similar to that of the first indication information, which shall not be repeated herein any further. That the terminal equipment determines the record triggering configuration of the first report configured by the first network device includes that the terminal equipment may determine the record triggering configuration configured by the first network device according to relevant information element information or the transmission mode in the record triggering configuration or the second indication information.

In this implementation, when determining to record the first report, contents of recorded in the first report may also be determined according to the type of the primary secondary cell change and according to the relevant information of the target primary secondary cells, that is, when determining that the relevant information is configured by the first network device, the contents of recorded in the first report are determined according to relevant configurations configured by the first network device. The relevant configurations configured by the first network device may include a measurement object and/or a position information acquisition configuration. If the relevant configurations configured by the first network device include the measurement object configuration, the first report includes measurement result information of a measurement object configured by the first network device; and/or, if the relevant configuration configured by the first network device includes the position information acquisition configuration, the first report includes position information determined according to the position information acquisition configuration. The measurement result information includes at least one of the following information: reference signal receiving power (RSRP), reference signal receiving quality (RSRQ), a reference signal strength indicator (RSSI), a signal to interference plus noise ratio (SINR), or other signal quality information.

For example, both the master network device (MN) and the secondary network device (SN) transmit relevant configurations via SRB1, wherein the configuration transmitted by the MN to the UE includes {frequency points 1, 2, 3, position information acquisition configuration 1}, and the relevant configuration transmitted by the SN to the UE includes {frequency points 4, 5, 6, position information acquisition configuration 2}. If it is determined that the executed primary secondary cell mobility is triggered/configured by the MN, the UE determines to record the first report according to the report triggering configuration configured by the MN, and the UE records measurement results of frequency points 1, 2 and 3 and/or position 1 in the first report, and if the executed primary secondary cell mobility is triggered/configured by the (source) SN, the UE determines to record the first report according to the report triggering configuration configured by the (source) SN, and the UE records measurement results of frequency points 4, 5 and 6 and/or position 2 in the first report.

As some possible implementations, for example, in Implementation 2, the first report is determined to be recorded according to a type of a signal radio bearer SRB transmitting the first configuration information, and contents of the first report are further determined. For a scenario of an ordinary primary secondary cell change, if the first configuration information is carried in SRB3, the terminal equipment may directly determine that the primary secondary cell change configuration is configured by the secondary network device (the primary secondary cell change is triggered by the secondary network device), and the first report is determined to be recorded according to the record triggering configuration of the (source) secondary network device. For the scenario of an ordinary primary secondary cell change, if the SRB carrying the primary secondary cell configuration is SRB1, the terminal equipment may further determine a network device which triggers the primary secondary cell change according to the first indication information. When determining the first report, the contents of recorded in the first report may also be determined according to relevant configurations to which the network devices that triggers the primary secondary cell change. If the first configuration information is carried in SRB3, the terminal equipment determines the contents recorded in the first report according to the record triggering configuration of the (source) secondary network device and according to the relevant configurations of the (source) secondary network device. The relevant configuration is as described above, and shall not be repeated herein any further.

As some possible implementations, for example, in Implementation 3, when distinguishing network devices that trigger the primary secondary cell change according to the first indication information, the type of primary secondary cell change needs to be taken into account when determining to record the first report. If the type of the primary secondary cell change is an ordinary primary secondary cell change and the first indication information is configured, the terminal equipment may directly determine that the primary secondary cell change configuration is configured by the secondary network device (the primary secondary cell change is triggered by the secondary network device), and may determine to record the first report according to the record triggering configuration of the source secondary network device; and/or, if the type of the primary secondary cell change is an ordinary primary secondary cell change and the first indication information is not configured, the terminal equipment may directly determine that the primary secondary cell change configuration is configured by the master network device (the primary secondary cell change is triggered by the master network device), and may determine to record the first report according to the record triggering configuration of the master network device. In this implementation, when determining the first report, if the type of the primary secondary cell change is an ordinary primary secondary cell change and the first indication information is configured, the terminal equipment may directly determine that the primary secondary cell change configuration is configured by the secondary network device (the primary secondary cell change is triggered by the secondary network device), and may further determine the contents recorded in the first report according to the relevant configurations of the source secondary network device; and/or, if the type of the primary secondary cell change is an ordinary primary secondary cell change and the first indication information is not configured, the terminal equipment may directly determine that the primary secondary cell change configuration is configured by the master network device (the primary secondary cell change is triggered by the master network device), and may further determine the contents recorded in the first report according to the relevant configurations of the source master network device. If the type of the primary secondary cell change is a conditional primary secondary cell change and the first indication information is configured, the first indication information related to the target primary secondary cell is configured, and the terminal equipment determines to record the first report according to the record triggering configuration of the source secondary network device; and/or, if the primary secondary cell change is a conditional primary secondary cell change and the first indication information related to the target primary secondary cell is not configured, the terminal equipment may determine to record the first report according to the record triggering configuration of the source master network device. In this implementation, in determining the first report, if the type of primary secondary cell change is a conditional primary secondary cell change and the first indication information related to the target primary secondary cell is configured, the terminal equipment determines that the conditional primary secondary cell change is triggered by the secondary network device, and may further determine the contents recorded in the first report according to the relevant configurations of the source secondary network device; and/or, if the type of primary secondary cell change is a conditional primary secondary cell change and the first indication information related to the target primary secondary cell is not configured, the terminal equipment may directly determine that the conditional primary secondary cell change is triggered by the master network device, and may further determine the contents recorded in the first report according to the relevant configurations of the source master network device. The relevant configurations are as described above, and shall not be repeated herein any further.

In some embodiments, in the above three possible implementations, if the terminal equipment needs to record the first report, the contents of the first report further include: if the terminal equipment has a global cell identifier and a tracking area code of the source primary secondary cell, the first report includes source primary secondary cell information that is the global cell identifier and tracking area code; and if there is no global cell identifier and/or tracking area code of the source primary secondary cell, the first report further includes a physical cell identifier and frequency point information of the source primary secondary cell.

How to determine whether to record the first report and how to determine the contents of the first report in Implementation 1, Implementation 2 and Implementation 3 shall be described below by way of examples.

### (I) Implementation 1

A mechanism for the terminal equipment to determine whether to record the first report shall be described below.

If the terminal equipment determines that the ratio of the runtime of T304 to the maximum runtime of T304 is greater than or equal to the T304 trigger threshold, the UE stores information related to the primary secondary cell mobility (i.e. recording the first report), and/or determines the contents of the first report; or
if the first indication information is configured, or if in a scenario of a conditional primary secondary cell change, the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in a scenario of a conditional primary secondary cell change, a target primary secondary cell determined or selected by the terminal equipment is configured by the source primary secondary cell (also referred to as a source secondary network device), or an execution condition that the target primary secondary cell satisfied determined or selected by the terminal equipment is configured by the source primary secondary cell (also referred to as a source secondary network device), and the ratio of the runtime of T310 to the maximum runtime of T310 is greater than or equal to the T310 trigger threshold configured by the source primary secondary cell, the UE stores information related to the primary secondary cell mobility (i.e. recording the first report), and/or determines the contents of the first report; or
if the first indication information is configured (such as in a scenario of an ordinary primary secondary cell change), or (in a scenario of a conditional primary secondary cell change) if in a scenario of a conditional primary secondary cell change, the terminal equipment determines that the target primary secondary cell is configured by the source primary secondary cell (also referred to as a source secondary network device), or the terminal equipment determines that an execution condition that the target primary secondary cell satisfies is configured by the source primary secondary cell (also referred to as a source secondary network device), or if in a scenario of a conditional primary secondary cell change, the target primary secondary cell determined or selected by the terminal equipment is configured by the source primary secondary cell (also referred to as a source secondary network device), or an execution condition that the target primary secondary cell satisfies determined or selected by the terminal equipment is configured by the source primary secondary cell (also referred to as a source secondary network device), and if the ratio of the runtime of T312 corresponding to the frequency point or measurement identification information to which the target cell corresponds to the maximum runtime of T312 is greater than or equal to the T312 trigger threshold configured by a corresponding source primary secondary cell, the UE stores information related to the primary secondary cell mobility (i.e. recording the first report), and/or determines the contents of the first report;
as an example, when the UE is connected to the source primary secondary cell before performing a last time of primary secondary cell mobility configuration, if in a scenario of a conditional primary secondary cell change (CPC), the target PSCell selected by the UE is configured by the source primary secondary cell, or if an execution condition that the target PSCell satisfies selected by the UE is configured by the source primary secondary cell, the terminal equipment determines whether to record the first report according to the record triggering configuration configured by the source primary secondary cell (such as at least one of the T310 trigger threshold, T312 trigger threshold, or other timer trigger threshold);
or,
if the first indication information is not configured (such as in a scenario of an ordinary primary secondary cell change), or if in a scenario of a conditional primary secondary cell change, the terminal equipment determines that the target primary secondary cell is configured by the source primary cell (also referred to as a source master network device), or the terminal equipment determines that an execution condition that the target primary secondary cell satisfies is configured by the source primary cell (also referred to as a source master network device), or if in a scenario of a conditional primary secondary cell change, the target primary secondary cell determined or selected by the terminal equipment is configured by the source primary cell (also referred to as a source master network device), or an execution condition that the target primary secondary cell satisfies determined or selected by the terminal equipment is configured by the source primary cell (also referred to as a source master network device), and if the ratio of the runtime of T310 to the maximum runtime of T310 is greater than or equal to the T310 trigger threshold configured by the source primary cell, the UE stores information related to the primary secondary cell mobility (i.e. recording the first report), and/or determines the contents of the first report;
or,
if the first indication information is not configured (such as in a scenario of an ordinary primary secondary cell change), or if in a scenario of a conditional primary secondary cell change, the target primary secondary cell determined by the terminal equipment is configured by the source primary cell (also referred to as a source master network device), or the execution condition that the target primary secondary cell satisfies determined by the terminal equipment is configured by the source primary cell (also referred to as a source master network device), or if the ratio of the runtime of T312 corresponding to the frequency point or measurement identification information to which target cell corresponds to the maximum runtime of T312 is greater than or equal to the T312 trigger threshold configured by a corresponding source primary cell, the UE stores information related to the primary secondary cell mobility (i.e. recording the first report), and/or determines the contents of the first report.

As an example, when the UE is connected to the source primary secondary cell before performing a last time of primary secondary cell mobility configuration, if in a scenario of a conditional primary secondary cell change (CPC), the target PSCell selected by the UE is configured by the source primary cell, or if an execution condition that the target PSCell satisfies selected by the UE is configured by the source primary cell, the terminal equipment determines whether to record the first report according to the record triggering configuration configured by the source primary cell.

How the terminal equipment determines the contents of the first report shall be described below.

If the first indication information is configured (such as in a scenario of an ordinary primary secondary cell change), or (in a scenario of a conditional primary secondary cell change) if the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in a scenario of a conditional primary secondary cell change, the target primary secondary cell determined or selected by the terminal equipment is configured by the source primary secondary cell (also referred to as source secondary network device), or the execution condition that the target primary secondary cell determined or selected by the terminal equipment satisfies is configured by the source primary secondary cell (also referred to as a source secondary network device), the terminal equipment determines the contents of the first report according to the relevant configurations of the source primary secondary cell. For example, the terminal equipment records measurement result information corresponding to the measurement object information in the relevant configurations of the source primary secondary cell in the first report, and/or the terminal equipment sets the position information in the first report according to the relevant configurations of the source primary secondary cell; or
if the first indication information is not configured (such as in a scenario of an ordinary primary secondary cell change), or if the terminal equipment determines that the target primary secondary cell is configured by the source primary cell (also referred to as a source master network device), or the terminal equipment determines that the execution condition that the target primary secondary cell satisfies is configured by the source primary cell (also referred to as a source master network device), or if in a scenario of a conditional primary secondary cell change, the determined or selected target primary secondary cell is configured by the source primary cell (also referred to as source primary secondary network device), or the determined or selected execution condition that the target primary secondary cell satisfies is configured by the source primary cell (also referred to as a source master network device), the terminal equipment determines the contents of the first report according to the relevant configurations of the source primary cell. For example, the terminal equipment records measurement result information corresponding to the measurement object information configured by the source primary cell in the first report, and/or the terminal equipment sets the position information in the first report according to the relevant configurations of the source primary cell.

If the terminal equipment needs to record the first report, the contents of the first report further include: if there are a global cell identifier and a tracking area code of the source primary secondary cell, the first report includes source primary secondary cell information that is the global cell identifier and the tracking area code; and if there is no global cell identifier and/or tracking area code of the source primary secondary cell, the first report further includes a physical cell identifier (PCI) and frequency point information of the source primary secondary cell.

### (II) Implementation 2

A mechanism for how the terminal equipment determines whether to record the first report shall be described below.

If the terminal equipment determines that the ratio of the runtime of T304 to the maximum runtime of T304 is greater than or equal to the T304 trigger threshold, the UE stores information related to the primary secondary cell mobility (i.e. recording the first report), and/or determines the contents of the first report; or,
if the first indication information is configured, or (in the case where the first indication information is not configured) if the primary secondary cell mobility received by the terminal equipment is carried in SRB3, or, if in the scenario of a conditional primary secondary cell change, the terminal equipment determines that the target primary secondary cell is configured by the source primary secondary cell (also referred to as a source secondary network device), or the execution condition that the target primary secondary cell satisfies determined by the terminal equipment is configured by the source primary secondary cell (also referred to as a source secondary network device), or if in the scenario of a conditional primary secondary cell change, the target primary secondary cell determined or selected by the terminal equipment is configured by the source primary secondary cell (also referred to as a source secondary network device), or the execution condition that the target primary secondary cell satisfies determined or selected by the terminal equipment is configured by the source primary secondary cell (also referred to as a source secondary network device), and if the ratio of the runtime of T310 to the maximum runtime of T310 is greater than or equal to the T310 trigger threshold configured by the source primary secondary cell, the UE stores information related to the primary secondary cell mobility (i.e. recording the first report), and/or determines the contents of the first report; or
if the first indication information is configured, or (in the case where the first indication information is not configured) if the primary secondary cell mobility received by the terminal equipment is carried in SRB3, or, if in the scenario of a conditional primary secondary cell change, the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in the scenario of a conditional primary secondary cell change, the target primary secondary cell determined or selected by the terminal equipment is configured by the source primary secondary cell (also referred to as a source secondary network device), or the execution condition that the target primary secondary cell satisfies determined or selected by the terminal equipment is configured by the source primary secondary cell (also referred to as a source secondary network device), and if the ratio of the runtime of T312 corresponding to the frequency point or measurement identification information to which the target cell corresponds to the maximum runtime of T312 is greater than or equal to the T312 trigger threshold configured by the corresponding source primary secondary cell, the UE stores information related to the primary secondary cell mobility (i.e. recording the first report), and/or determines the contents of the first report; or
if the first indication information is not configured (such as in the scenario of an ordinary primary secondary cell change), or if in the scenario of a conditional primary secondary cell change, the terminal equipment determines that the target primary secondary cell is configured by the source primary cell (also referred to as a source master network device), or the terminal equipment determines that the execution condition that the target primary secondary cell satisfies is configured by the source primary cell (also referred to as a source master network device), or if in the scenario of a conditional primary secondary cell change, the target primary secondary cell determined or selected by the terminal equipment is configured by the source primary cell (also referred to as a source master network device), or the execution condition that the target primary secondary cell satisfies determined or selected by the terminal equipment is configured by the source primary cell (also referred to as a source master network device), and if the ratio of the runtime of T310 to the maximum runtime of T310 is greater than or equal to the T310 trigger threshold configured by the source primary cell, the UE stores information related to the primary secondary cell mobility (i.e. recording the first report), and/or determines the contents of the first report; or
if the first indication information is not configured (such as in the scenario of an ordinary primary secondary cell change), (or if in the scenario of a conditional primary secondary cell change) the target primary secondary cell determined by the terminal equipment is configured by the source primary cell (also referred to as a source master network device), or the execution condition that the target primary secondary cell satisfies determined by the terminal equipment is configured by the source primary cell (also referred to as a source master network device), and if the ratio of the runtime of T312 corresponding to the frequency point or measurement identification information to which the target cell corresponds to the maximum runtime of T312 is greater than or equal to the T312 trigger threshold configured by the corresponding source primary cell, the UE stores information related to the primary secondary cell mobility (i.e. recording the first report), and/or determines the contents of the first report.

How the terminal equipment determines the contents of the first report shall be described below.

If the first indication information is configured, or (in the case where the first indication information is not configured) if the primary secondary cell mobility received by the terminal equipment is carried in SRB3, or, if the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in the scenario of a conditional primary secondary cell change, the target primary secondary cell determined or selected by the terminal equipment is configured by the source primary secondary cell (also referred to as a source secondary network device), or the execution condition that the target primary secondary cell satisfies determined or selected by the terminal equipment is configured by the source primary secondary cell (also referred to as a source secondary network device), the terminal equipment determines the contents of the first report according to the relevant information of the source primary secondary cell. For example, the terminal equipment records the measurement result information to which the measurement object information in the relevant configuration of the source primary secondary cell corresponds in the first report, and/or the terminal equipment sets position information in the first report according to the relevant configurations of the source primary secondary cell; or
if the first indication information is not configured (such as in a scenario of an ordinary primary secondary cell change), or if the terminal equipment determines that the target primary secondary cell is configured by the source primary cell (also referred to as a source master network device), or if the terminal equipment determines that the execution condition that the target primary secondary cell satisfies is configured by the source primary cell (also referred to as a source master network device), or if in a scenario of a conditional primary secondary cell change, the determined or selected target primary secondary cell is configured by the source primary cell (also referred to as a source primary secondary network device), or the execution condition that the determined or selected target primary secondary cell satisfies is configured by the source primary cell (also referred to as a source master network device), the terminal equipment determines the contents of the first report according to the relevant configurations of the source primary cell. For example, the terminal equipment records the measurement result information to which the measurement object information in the relevant configuration of the source primary cell corresponds in the first report, and/or the terminal equipment sets position information in the first report according to the relevant configurations of the source primary cell.

If the terminal equipment needs to record the first report, the contents of the first report further include: if there are a global cell identifier and a tracking area code of the source primary secondary cell, the first report includes source primary secondary cell information that is the global cell identifier and the tracking area code; and if there is no global cell identifier and/or tracking area code of the source primary secondary cell, the first report further includes a physical cell identifier (PCI) and frequency point information of the source primary secondary cell.

### (III) Implementation 3

A mechanism for how the terminal equipment determines whether to record the first report shall be described below.

If the terminal equipment determines that the ratio of the runtime of T304 to the maximum runtime of T304 is greater than or equal to the T304 trigger threshold, the UE stores information related to the primary secondary cell mobility (i.e. recording the first report), and/or determines the contents of the first report; or
if the first indication information is configured in a scenario of an ordinary primary secondary cell change, or in a scenario of a conditional primary secondary cell change) if in a scenario of a conditional primary secondary cell change, the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in a scenario of a conditional primary secondary cell change, the target primary secondary cell determined or selected by the terminal equipment is configured by the source primary secondary cell (also referred to as a source secondary network device), or the execution condition that the target primary secondary cell determined or selected by the terminal equipment satisfies is configured by the source primary secondary cell (also referred to as a source secondary network device), or the terminal equipment determines that the first indication information related to the target primary secondary cell is configured, and if the ratio of the runtime of T310 to the maximum runtime of T310 is greater than or equal to the T310 trigger threshold configured by the source primary secondary cell, the UE stores the information related to the source primary secondary cell mobility (i.e. recording the first report), and/or determines the contents of the first report; or
if the first indication information is configured, or if in the scenario of a conditional primary secondary cell change, the terminal equipment determines that the target primary secondary cell is configured by the source primary secondary cell (also referred to as a source primary secondary network device), or the terminal equipment determines that the execution condition that the target primary secondary cell satisfies is configured by the source primary secondary cell (also referred to as a source primary secondary network device), or if in the scenario of a conditional primary secondary cell change, the target primary secondary cell determined or selected by the terminal equipment is configured by the source primary secondary cell (also referred to as a source secondary network device), or the execution condition that the target primary secondary cell satisfies determined by the terminal equipment is configured by the source primary secondary cell (also referred to as a source secondary network device), or the terminal equipment determines that the first indication information related to the target primary secondary cell is configured, and if the ratio of the runtime of T312 corresponding to the frequency point or measurement identification information to which the target cell corresponds to the maximum runtime of T312 is greater than or equal to the T312 trigger threshold configured by the corresponding source primary secondary cell, the UE stores information related to the primary secondary cell mobility (i.e. recording the first report), and/or determines the contents of the first report; or
if the first indication information is not configured (such as in the scenario of an ordinary primary secondary cell change, or in the scenario of a conditional primary secondary cell change), or in the scenario of a conditional primary secondary cell change, the terminal equipment determines that the target primary secondary cell is configured by the source primary cell (also referred to as a source master network device), or the terminal equipment determines that the execution condition that the target primary secondary cell satisfies is configured by the source primary cell (also referred to as a source master network device), or if in the scenario of a conditional primary secondary cell change, the target primary secondary cell determined or selected by the terminal equipment is configured by the source primary cell (also referred to as a source master network device), or the execution condition that the target primary secondary cell satisfies determined or selected by the terminal equipment is configured by the source primary cell (also referred to as a source master network device), or the terminal equipment determines that the first indication information related to the target primary secondary cell is not configured, and if the ratio of the runtime of T310 to the maximum runtime of T310 is greater than or equal to the T310 trigger threshold configured by the source primary cell, the UE stores information related to the primary secondary cell mobility (i.e. recording the first report), and/or determines the contents of the first report; or
if the first indication information is not configured (such as in the scenario of an ordinary primary secondary cell change, or in the scenario of a conditional primary secondary cell change), or in the scenario of a conditional primary secondary cell change, the target primary secondary cell determined by the terminal equipment is configured by the source primary cell (also referred to as a source master network device), or the execution condition that the target primary secondary cell satisfies determined by the terminal equipment is configured by the source primary cell (also referred to as a source master network device), or terminal equipment determines that the first indication information related to the target primary secondary cell is not configured, and if the ratio of the runtime of T312 corresponding to the frequency point or measurement identification information to which the target cell corresponds to the maximum runtime of T312 is greater than or equal to the T312 trigger threshold configured by the corresponding source primary cell, the UE stores information related to the primary secondary cell mobility (i.e. recording the first report), and/or determines the contents of the first report.

How the terminal equipment determines the contents of the first report shall be described below.

In the scenario of an ordinary primary secondary cell change, if the first indication information is configured, or (in the scenario of a conditional primary secondary cell change) if the terminal equipment determines that the target primary secondary cell is configured by the source primary secondary cell (also referred to as a source secondary network device), or the terminal equipment determines that the execution condition that the target primary secondary cell satisfies is configured by the source primary secondary cell (also referred to as a source secondary network device), or if in a scenario of a conditional primary secondary cell change, the target primary secondary cell determined or selected by the terminal equipment is configured by the source primary secondary cell (also referred to as source secondary network device), or the execution condition that the target primary secondary cell satisfies determined or selected by the terminal equipment is configured by the source primary secondary cell (also referred to as a source secondary network device), or, the terminal equipment determines that the first indication information related to the target primary secondary cell is configured, the terminal equipment determines the contents of the first report according to the relevant configurations of the source primary secondary cell. For example, the terminal equipment records the measurement result information to which the measurement object information in the relevant configurations of the source primary secondary cell corresponds in the first report, and/or the terminal equipment sets position information in the first report according to the relevant configurations of the source primary secondary cell; or
if the first indication information is not configured (such as in a scenario of an ordinary primary secondary cell change), or if the terminal equipment determines that the target primary secondary cell is configured by the source primary cell (also referred to as a source master network device), or if the terminal equipment determines that the execution condition that the target primary secondary cell satisfies is configured by the source primary cell (also referred to as a source master network device), or if in a scenario of a conditional primary secondary cell change, the determined or selected target primary secondary cell is configured by the source primary cell (also referred to as a source primary secondary network device), or the execution condition that the determined or selected target primary secondary cell satisfies is configured by the source primary cell (also referred to as a source master network device), or the terminal equipment determines that the first indication information related to the target primary secondary cell is not configured, the terminal equipment determines the contents of the first report according to the relevant configurations of the source primary cell. For example, the terminal equipment records the measurement result information to which the measurement object information in the relevant configuration of the source primary cell corresponds in the first report, and/or the terminal equipment sets position information in the first report according to the relevant configurations of the source primary cell.

If the terminal equipment needs to record the first report, the contents of the first report further include: if there are a global cell identifier and a tracking area code of the source primary secondary cell, the first report includes source primary secondary cell information that is the global cell identifier and the tracking area code; and if there is no global cell identifier and/or tracking area code of the source primary secondary cell, the first report further includes a physical cell identifier (PCI) and frequency point information of the source primary secondary cell.

In some embodiments, the method may further include: transmitting the first report to the network device.

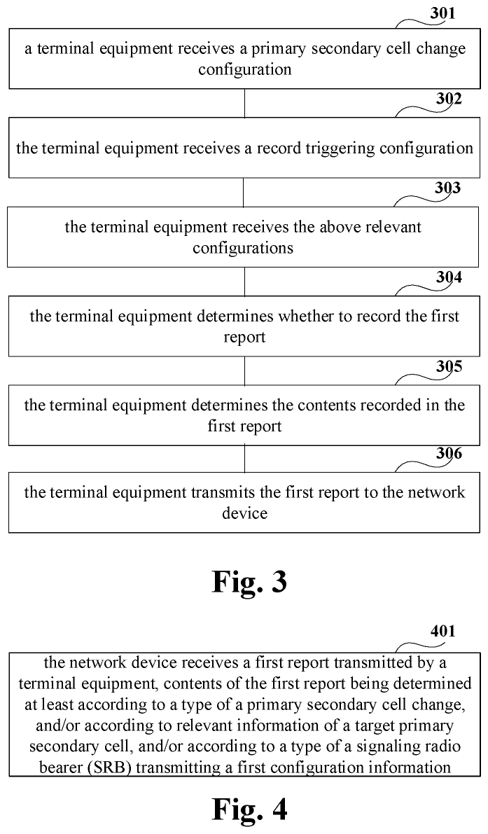

FIG. 3 is a schematic diagram of the report transmission method of the embodiments of this disclosure. As shown in FIG. 3, the method includes:
301: a terminal equipment receives a primary secondary cell change configuration;
302: the terminal equipment receives a record triggering configuration;
303: the terminal equipment receives the above relevant configurations;
304: the terminal equipment determines whether to record the first report;
305: the terminal equipment determines the contents recorded in the first report; and
306: the terminal equipment transmits the first report to the network device.

Implementations of 301-306 are as described above, and shall not be repeated herein any further. An optional method may further include: the terminal equipment receives the first indication information. Reference may be made to the above embodiments for details, which shall not be repeated herein any further. Configurations and first indication information in 301-303 may be carried by identical signaling or information element, or by different signaling or information elements, and the embodiments of this disclosure is not limited thereto.

It should be noted that FIGS. 2 and 3 only schematically illustrate the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 2 and 3.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, the terminal equipment is enabled to determine the network device triggering mobility of a primary secondary cell, thereby determining whether to record a problem of potential failure in a primary secondary cell mobility procedure and the recorded contents, which avoids recording erroneous or redundant contents, ensures robustness, and reduces unnecessary signaling overhead.

### Embodiment of a Second Aspect

The embodiments of this disclosure provide a report reception method, which shall be described from a network device side.

FIG. 4 is a schematic diagram of the report reception method of the embodiments of this disclosure. As shown in FIG. 4, the method includes:
401: the network device receives, a first report transmitted by a terminal equipment, contents of the first report being determined at least according to a type of a primary secondary cell change, and/or according to relevant information of a target primary secondary cell, and/or according to a type of a signaling radio bearer (SRB) transmitting a first configuration information.

It should be noted that FIG. 4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

Reference may be made to the embodiments of the first aspect for implementation of the first report, which shall not be repeated herein any further.

According to the embodiments of this disclosure, the terminal equipment is enabled to determine the network device triggering mobility of a primary secondary cell, thereby determining whether to record a problem of potential failure in a primary secondary cell mobility procedure and the recorded contents, which avoids recording erroneous or redundant contents, ensures robustness, and reduces unnecessary signaling overhead.

### Embodiment of a Third Aspect

The embodiments of this disclosure provide a report recording apparatus.

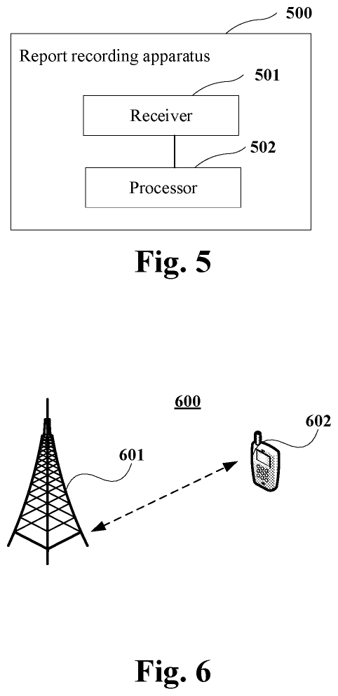

FIG. 5 is a schematic diagram of the report recording apparatus of the embodiments of this disclosure. The device may be, for example, a terminal equipment, or one or some components or assemblies configured in the terminal equipment. As a principle of the apparatus is identical to that of the method in the embodiments of the first aspect, reference may be made to the implementation of the embodiments of the first aspect for implementation of the apparatus, with identical parts being not going to be described herein any further.

As shown in FIG. 5, the apparatus 500 includes:
a receiver 501 configured to receive first configuration information indicating a primary secondary cell change configuration, the primary secondary cell change including an ordinary primary secondary cell change or a conditional primary secondary cell change; and
a processor 502 configured to determine to record a first report according to a type of the primary secondary cell change, and/or according to relevant information of a target primary secondary cell, and/or according to a type of a signaling radio bearer (SRB) transmitting the first configuration information.

Reference may be made to the embodiments of the first aspect for implementations of the receiver 501 and the processor 502, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the above apparatus may further include other components or modules, and reference may be made to related techniques for particulars of these components or modules. Furthermore, the above components or modules may be implemented by hardware, such as a processor, a memory, a transmitter, and a receiver, etc., which are not limited in the embodiments of this disclosure.

According to the embodiments of this disclosure, the terminal equipment is enabled to determine the network device triggering mobility of a primary secondary cell, thereby determining whether to record a problem of potential failure in a primary secondary cell mobility procedure and the recorded contents, which avoids recording erroneous or redundant contents, ensures robustness, and reduces unnecessary signaling overhead.

### Embodiment of a Fourth Aspect

The embodiments of this disclosure provide a communication system, including a network device and/or a terminal equipment.

FIG. 6 is a schematic diagram of the communication system of the embodiments of this disclosure. As shown in FIG. 6, the communication system 600 may include a network device 601 and a terminal equipment 602.

In some embodiments, the terminal equipment 602 is configured to carry out the method described in the embodiments of the first aspect. As the method has been described in detail in the embodiments of the first aspect, the contents thereof are incorporated herein, and being not going to be described herein any further.

The embodiments of this disclosure further provide a terminal equipment.

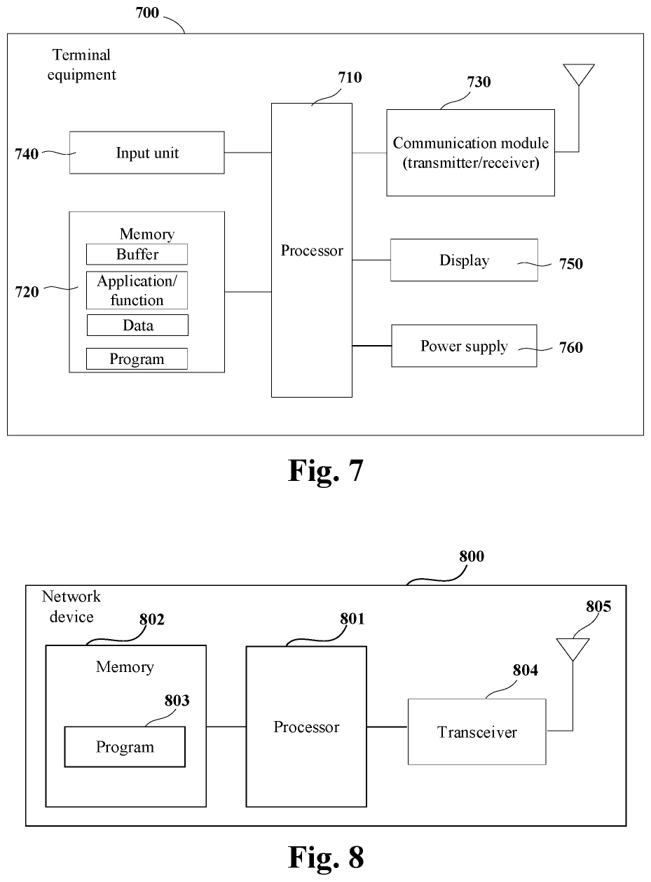

FIG. 7 is a schematic diagram of the terminal equipment of the embodiments of this disclosure. As shown in FIG. 7, the terminal equipment 700 may include a processor 710 and a memory 720, the memory 720 storing data and a program, and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiments of the first aspect.

As shown in FIG. 7, the terminal equipment 700 may further include a communication module (a receiver or a transmitter) 730, an input unit 740, a display 750, and a power supply 760, wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

The embodiments of this disclosure further provide a network device, which may be, for example, a base station. However, this disclosure is not limited thereto, and it may also be another network device.

FIG. 8 is a schematic diagram of the network device of the embodiments of this disclosure. As shown in FIG. 8, the network device 800 may include a processor 801 and a memory 802, the memory 802 being coupled to the processor 801. Wherein, the memory 802 may store various data, and furthermore, it may store a program 803 for information processing, and execute the program under control of the processor 801.

In some embodiments, the processor 801 may be configured to control a transceiver to execute a program to carry out the method in the embodiments of the second aspect, the contents of which being incorporated herein, and being not going to be described herein any further.

Furthermore, as shown in FIG. 8, the network device 800 may include a transceiver 804, and an antenna 805, etc., wherein functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

Embodiments of this disclosure provide a computer program, which, when executed in a network device, will cause the network device to carry out the method as described in the embodiments of the second aspect.

Embodiments of this disclosure provide a storage medium, including a computer program, which will cause a network device to carry out the method as described in the embodiments of the second aspect.

Embodiments of this disclosure provide a computer program, which, when executed in a terminal equipment, will cause the terminal equipment to carry out the method as described in the embodiments of the first aspect.

Embodiments of this disclosure provides a storage medium, including a computer program, which will cause a terminal equipment to carry out the method as described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.
1. A report reception method, wherein the method includes:
   receiving, by a network device, a first report transmitted by a terminal equipment, contents of the first report being determined at least according to a type of a primary secondary cell change, and/or according to relevant information of a target primary secondary cell, and/or according to a type of a signaling radio bearer (SRB) of a first configuration information.
2. A network device, including:
   a receiver configured to receive first report transmitted by a terminal equipment, contents of the first report being determined at least according to a type of a primary secondary cell change, and/or according to relevant information of a target primary secondary cell, and/or according to a type of a signaling radio bearer (SRB) of a first configuration information.

1. A report recording apparatus, applicable to a terminal equipment, comprising:
a receiver configured to receive first configuration information indicating a configuration of a primary secondary cell (PSCell) change, the PSCell change comprising a first type of a PSCell change or a second type of a PSCell change, wherein the first type of a PSCell change is a PSCell change where the terminal equipment executes a PSCell change procedure immediately upon receiving a target PSCell configuration transmitted by a network device, and wherein the second type of a PSCell change is a conditional PSCell change (CPC); and
processor circuitry configured to record a first report according to whether a first indication information is configured and a type of a PSCell change, wherein the first indication information is used to indicate that the first type of a PSCell change or the second type of a PSCell change comprised in the first configuration information is initiated by a secondary network device.

2. The apparatus according to claim 1, wherein the second type of a PSCell change is a type of PSCell change that is different from the first type of a PSCell change.

3. The apparatus according to claim 2, wherein the first configuration information comprises a record triggering configuration of the first report, the record triggering configuration being used by the terminal equipment to determine whether to record the first report.

4. The apparatus according to claim 2, wherein the first configuration information is configured by a master network device, and/or configured by a source secondary network device.

5. The apparatus according to claim 3, wherein
if the type of the PSCell change is a conditional PSCell change and the first indication information is configured, the processor circuitry records the first report according to the record triggering configuration configured by a source secondary network device;
if the type of the PSCell change is a conditional PSCell change and the first indication information is not configured, the processor circuitry records the first report according to the record triggering configuration configured by a master network device.

6. The apparatus according to claim 5, wherein that first indication information is configured comprises that: the target PSCell is configured by the source secondary network device, and/or an execution condition to which the target PSCell corresponds is configured by the source secondary network device.

7. The apparatus according to claim 5, wherein when the processor circuitry determines that relevant information of a target PSCell is configured by a network device, the processor circuitry further determines contents recorded in the first report according to a relevant configuration configured by the network device.

8. The apparatus according to claim 5, wherein the first configuration information further comprises or does not comprise first indication information, when the first configuration information comprises the first indication information, the first type of a PSCell change or the second type of a PSCell change comprised in the first configuration information is initiated by a secondary network device, when the first configuration information does not comprise the first indication information, the first type of a PSCell change or the second type of a PSCell change comprised in the first configuration information is initiated by a master network device.

9. The apparatus according to claim 8, wherein when the first configuration information is transmitted via Signaling Radio Bearer (SRB) 3, the first configuration information further comprises the first indication information.

10. The apparatus according to claim 9, wherein
if the first configuration information is carried in the SRB 3, the processor circuitry records the first report according to the record triggering configuration of the source secondary network device.

11. The apparatus according to claim 10, wherein if the first configuration information is carried in the SRB 3, the processor circuitry further determines contents recorded in the first report according to a relevant configuration of the source secondary network device.

12. The apparatus according to claim 8, wherein
if the type of the PSCell change is the first type of a PSCell change and the first indication information is configured, the processor circuitry records the first report according to the record triggering configuration of the source secondary network device;
and/or, if the type of the PSCell change is the first type of a PSCell change and the first indication information is not configured, the processor circuitry records the first report according to the record triggering configuration of the master network device.

13. The apparatus according to claim 12, wherein if the type of the PSCell change is the first type of a PSCell change and the first indication information is configured, the processor circuitry further determines contents recorded in the first report according to a relevant configuration of the source secondary network device; and/or,
if the type of the PSCell change is the first type of a PSCell change and the first indication information is not configured, the processor circuitry further determines contents recorded in the first report according to a relevant configuration of the master network device.

14. The apparatus according to claim 7, wherein the relevant configuration comprises a configuration of a measurement object, and the first report comprises measurement result information of the measurement object; and/or,
the relevant configuration comprises a position information acquisition configuration, and the first report comprises position information determined by the position information acquisition configuration.

15. The apparatus according to claim 7, wherein contents of the first report further comprise that:
if there are a global cell identifier and a tracking area code of a source PSCell, the first report comprises source PSCell information that is the global cell identifier and the tracking area code; and if there is no global cell identifier and/or tracking area code of a source PSCell, the first report further comprises a physical cell identifier and frequency point information of the source PSCell.

16. A report recording method, comprising:
receiving first configuration information indicating a configuration of a primary secondary cell (PSCell) change by a terminal equipment, the PSCell change comprising first type of a PSCell change or a second type of a PSCell change, wherein the first type of a PSCell change is a PSCell change where the terminal equipment executes a PSCell change procedure immediately upon receiving a target PSCell configuration transmitted by a network device, and wherein the second type of a PSCell change is a conditional PSCell change (CPC); and
recording a first report by the terminal equipment according to whether a first indication information is configured and a type of a PSCell change, wherein the first indication information is used to indicate that the first type of a PSCell change or the second type of a PSCell change comprised in the first configuration information is initiated by a secondary network device.

17. The method according to claim 16, wherein
if the type of the PSCell change is a conditional PSCell change and the first indication information is configured, recording the first report by the terminal equipment according to a record triggering configuration configured by a source secondary network device;
if the type of the PSCell change is a conditional PSCell change and the first indication information is not configured, recording the first report by the terminal equipment according to a record triggering configuration configured by a master network device.

18. The method according to claim 17, wherein that the first indication information is configured comprises that: the target PSCell is configured by the source secondary network device, and/or an execution condition to which the target PSCell corresponds is configured by the source secondary network device.

19. The method according to claim 16, wherein
if the first configuration information is carried in SRB 3, recording the first report by the terminal equipment according to a record triggering configuration of a source secondary network device.

20. A communication system, comprising a terminal equipment, the terminal equipment comprising:
a receiver configured to receive first configuration information indicating a configuration of a primary secondary cell (PSCell) change, the PSCell change comprising a first type of a PSCell change or a second type of a PSCell change, wherein the first type of a PSCell change is a PSCell change where the terminal equipment executes a PSCell change procedure immediately upon receiving a target PSCell configuration transmitted by a network device, and wherein the second type of a PSCell change is a conditional PSCell change (CPC); and
processor circuitry configured to record a first report according to whether a first indication information is configured and a type of a PSCell change, wherein the first indication information is used to indicate that the first type of a PSCell change or the second type of a PSCell change comprised in the first configuration information is initiated by a secondary network device.
